(19) United States
(12) Patent Application Publication
(10) Pub. No.: US 2020/0093573 A1
(43) Pub. Date: Mar. 26, 2020

(54) APPARATUSES AND METHODS FOR PRESERVATION OF LOOSE DENTITION

(71) Applicant: Advanced Orthodontics and Education Association, LLC, Ossining, NY (US)

(72) Inventors: Bryce A. WAY, San Jose, CA (US); Richard JOHNSON, Briarcliff Manor, NY (US)

(73) Assignee: Advanced Orthodontics and Education Association, LLC, Ossining, NY (US)

(21) Appl. No.: 16/139,444

(22) Filed: Sep. 24, 2018

(51) Int. Cl. A61C 7/00; A61C 7/08; A61C 19/06

(52) U.S. Cl. CPC A61C 7/008; A61C 8/0006; A61C 19/06; A61C 7/08

(57) ABSTRACT

Embodiments of the present disclosure are directed to devices and methods for reducing loose dentition during clear aligner treatment with vibration. According to various implementations, a vibrational dental device configured to vibrate at a frequency between about 20 Hz to about 250 Hz may be obtained. Subjects undergoing clear aligner treatment may be treated for about five minutes daily with the exemplary vibrational dental device. The extend of loose dentition can be reduced by the vibration treatment, while maintaining desired movement of the teeth during orthodontic treatment.

### CROSS-REFERENCE TO RELATED APPLICATIONS

This application is related to U.S. patent application Ser. No. 15/672,981, filed Aug. 9, 2017, which is a continuation-in-part of PCT/US2017/019767, U.S. patent application Ser. No. 15/875,779, filed Jan. 19, 2018, which is a continuation-in-part of U.S. patent application Ser. No. 15/672,981, filed Aug. 9, 2017, and U.S. patent application Ser. No. 16/139,268, concurrently filed herewith, entitled “Systems and Methods for Reducing Root Resorption in Orthodontic Treatment,” naming Bryce A. Way and Richard Johnson as inventors, all of which are incorporated by reference in their entirety.

### BACKGROUND

### Technical Field

The present disclosure generally relates to dental devices and methods. More particularly, and without limitation, the disclosed embodiments relate to devices, systems, and methods for preserving loose dentition.

### Background Description

Loose dentition may arise from periodontal diseases, such as periodontitis, which can cause resorption of the bone and loss of periodontal ligaments that support and hold the teeth in place. If left untreated, the teeth will not receive the support they need and become loose. Loose dentition may also arise in orthodontic treatment, such as with braces or clear aligners. Orthodontic forces on the teeth can cause apical root resorption or pathological shortening of the dental root, which can lead to permanent loss of root structure, resulting in increased tooth mobility. Loose teeth can make it difficult and painful to eat and talk. Loose teeth can progress and eventually detach completely from the gums and bone or need to be removed and replaced with a dental implant, which requires extensive and expensive dental care.

Previous studies suggest that mechanical vibration may enhance musculoskeletal properties. For example, some studies suggested that low-intensity mechanical vibrations may stimulate bone formation or mitigate the degradation of the intervertebral disc in rats. However, the biomolecular mechanisms for such enhancement effects have not yet been elucidated. Some studies suggested that mechanical vibration may enhance differentiation of human bone marrow mesenchymal stem cells or periodontal ligament stem cells. Some studies have suggested vibrations at frequencies ranging from 15 Hz to 90 Hz may be more anabolic to bone formation. See Zhang, C., et al. (2012). Effects of mechanical vibration on proliferation and osteogenic differentiation of human periodontal ligament stem cells. Archives of Oral Biology, 57(10), 1395-1407. Most of the previous studies subjected cells or animals to vibration treatments for a certain number of vibration bouts per day, each bout lasting for a duration ranging from 15 minutes to 60 minutes. See Judex, S., et al. (2015). Modulation of bone's sensitivity to low-intensity vibrations by acceleration magnitude, vibration duration, and number of bouts. Osteoporosis International, 26(4), 1417-1428. A recent study further suggested that increasing the bout duration to an even longer period (30 or 60 minutes) would positively influence bone formation rates in mice. See Pongkitwitoon, S., et al. (2016). Cytoskeletal Configuration Modulates Mechanically Induced Changes in Mesenchymal Stem Cell Osteogenesis, Morphology, and Stiffness. Scientific Reports, 6(1). doi:10.1038/srep34791.

It is recently hypothesized that mechanical vibration may promote alveolar bone and periodontal regeneration and remodeling and reduce root resorption, thereby reducing or repairing loose dentition during orthodontic treatment. However, variables of mechanical vibration to be used for modulating bone and periodontal biology so as to effectively preserve loose dentition remain to be determined.

### SUMMARY

The embodiments of the present disclosure include devices, systems, and methods for preserving loose dentition, such as loose dentition caused by orthodontic treatment, with mechanical stimulation, such as mechanical vibration. Advantageously, the exemplary embodiments may tighten loose dentition while achieving the desired tooth alignment with the orthodontic treatment.

According to an exemplary embodiment of the present disclosure, a method for treating a patient experiencing loose dentition in aligner treatment is described. The method may include providing a vibrational dental device configured to vibrate at a frequency between about 20 Hz and about 250 Hz, such as at a frequency higher than about 80 Hz. The method may further include providing instructions for treating the teeth of a patient with orthodontic aligners. The aligners may be configured to be worn in the mouth of a patient in a pre-determined sequence to move the patient's teeth substantially into a desired alignment. The aligners can be programmed for movement over any clinically meaningful distance, stepwise with each aligner change. The exact distance moved is usually determined by software, with an example being 0.25 mm of anterior-posterior movement on a target incisor. The method may additionally include providing instructions for mechanically stimulating, using the vibrational dental device, the teeth of the patient for about five minutes daily while the patient is wearing the aligners.

In some embodiments, the vibrational dental device may be configured to vibrate at a frequency between about 20 Hz and about 250 Hz, such as at a frequency of about 120 Hz. The method may additionally include treating the teeth with each aligner in the pre-determined sequence. For each aligner, treatment may include placing a mouthpiece of the vibrational dental device within the mouth of the patient while the patient is wearing the aligner and activating a vibration source of the vibrational dental device for a predetermined period of time while the aligner contacts the mouthpiece. For example, the predetermined period of time may be less than about 20 minutes daily, 15 minutes daily, 10 minutes daily, 6 minutes daily, 5 minutes daily, 4 minutes daily, or less. It is contemplated that in other embodiments the period of time may be any value within the range of about 1 minute and 19 minutes daily, and that the daily total treatment time could be formed of a plurality of treatment sessions contributing to the daily total treatment time. In one exemplary embodiment, the daily total treatment time is about 5 minutes. The mechanical stimulation may tighten the loose teeth in their sockets during aligner treatment.

According to another exemplary embodiment of the present disclosure, a method for reducing loose dentition by accelerating aligner treatment is described. The method may include providing instructions for treating the teeth of a patient that are treated with orthodontic aligners in a pre-determined sequence. The teeth may be treated with each aligner for a treatment period. For at least one aligner, the instructions for treating the teeth may include instructions for accelerating teeth movement by mechanically stimulating, using a vibrational dental device, the teeth of the patient at a frequency between about 20 Hz and about 250 Hz, such as at a frequency higher than about 80 Hz for about five minutes daily while the patient is wearing the aligner. The treatment period for the at least one aligner may be about 14 days or fewer. The acceleration of teeth movement due to the mechanical stimulation may reduce loosening of the patient's teeth.

According to another exemplary embodiment of the present disclosure, a method for treating a patient experiencing root resorption in aligner treatment is described. The method may include obtaining orthodontic aligners. The orthodontic aligners may be configured to be worn in the mouth of a patient in a pre-determined sequence to move the patient's teeth substantially into a desired alignment. The method may further include obtaining a vibrational dental device configured to vibrate at a frequency between about 20 Hz and about 250 Hz, such as at a frequency higher than about 80 Hz. The method may also include treating the teeth of a patient with the orthodontic aligners in the pre-determined sequence, and mechanically stimulating, using the vibrational dental device, loose teeth of the patient for about five minutes daily while the patient is wearing each orthodontic aligner. The treatment may tighten the loose teeth in their sockets during aligner treatment.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed. The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1A is a perspective view of an exemplary vibrational dental device, according to embodiments of the present disclosure.

FIG. 1B is a partial perspective view of the exemplary vibrational dental device of FIG. 1A, according to embodiments of the present disclosure.

FIG. 1C is a component view of the exemplary vibrational dental device of FIG. 1A, according to embodiments of the present disclosure.

FIG. 2 illustrates an operation of the exemplary vibrational dental device of FIG. 1.

### DETAILED DESCRIPTION

The disclosed embodiments relate to devices, systems, and methods for preserving loose dentition. Advantageously, embodiments of the present disclosure can be implemented during orthodontic treatment to reduce loosening of a patient's teeth while maintaining the desired movement of the teeth during the orthodontic treatment.

It is hypothesized that orthodontic forces applied to the teeth of a patient by bracket-and-wire braces or clear aligners, for example, can result in compression and tension in the periodontal ligament (PDL), which cause disturbance of blood flow in the PDL and damage the PDL. The damage can further cause hyalinization and induce an inflammatory response within the PDL, resulting in an influx of osteoclasts (bone resorbing cells) and osteoblasts (bone depositing cells). The inflammatory response allows for tooth movement but can also lead to undesirable complications. When the hyalinized tissue (necrotic tissue) is removed by osteoclasts, an imbalance between resorption and deposition can result in root resorption and eventually loose dentition.

It is further hypothesized that mechanical vibration with certain pre-determined variables, such as frequency, strength, and duration, may reduce or repair root resorption, thereby reducing loose dentition during orthodontic treatment. Biological responses of the human tissues due to the mechanical vibration may include increased blood circulation and altered tissue perfusion within the PDL. The increased vascularity and circulation associated with mechanical vibration may minimize hyalinization, thus leading to less orthodontic induced root resorption and less loose dentition. Also, the mechanical vibration may additionally stimulate osteoblastic activity and induce proliferation of osteoblasts in alveolar bone, thereby stimulating alveolar bone formation and remodeling around the teeth under treatment. Alveolar bone regeneration and remodeling may in turn repair root resorption and tighten up loose dentition. Moreover, the mechanical vibration may increase levels of cytokines in the body, which play an important role in eliminating the necrotic tissues involved in orthodontic root resorption. Finally, the mechanical vibration may stimulate the activity of periodontal ligament fibroblasts and induce its proliferation and differentiation into osteoblasts, which may generate new alveolar bone, cementum, or PDL fiber attachments, cause remodeling of alveolar bone and cementum, and reduce resorption, thereby reducing loose dentition.

According to an aspect of the present disclosure, a vibrational dental device that vibrates at a frequency between about 20 Hz and about 250 Hz, such as at a frequency higher than about 80 Hz is provided. The vibrational dental device includes a mouthpiece and a motor connected to the mouthpiece. The mouthpiece is configured to be provided between the occlusal surfaces of a user's teeth so as to be clamped by the user's teeth. The motor is configured to vibrate the mouthpiece at a frequency between about 20 Hz and about 250 Hz, such as at a frequency higher than about 80 Hz, such as at a frequency between about 100 Hz to about 120 Hz, and with an acceleration magnitude ranging between about 0.01 G and about 1 G, such as between about 0.03 G and about 0.2 G. When the motor is in operation and when the mouthpiece is clamped between the occlusal surfaces of a user's teeth, the vibrational dental device applies an axial vibratory force on the occlusal surfaces. Advantageously, mechanical vibration applied to loose teeth of a patient using the vibrational device reduces root resorption and/or stimulates the activity and proliferation of osteoblasts in alveolar bone and periodontal ligament fibroblasts, thereby tightening the loose teeth in their sockets.

In some embodiments, the vibrational dental device may further include a sensor configured to detect the vibration variables of the device, such as frequency and acceleration magnitude. When the mouthpiece of the vibrational dental device is clamped between the occlusal surfaces of a user's teeth, the sensor may detect the vibration variables proximate to the occlusal surfaces of the user's teeth. In some embodiments, the sensor is a piezoelectric sensor.

According to another aspect of the present disclosure, a method for treating a patient experiencing loose dentition is provided. The method includes mechanically stimulating, using an exemplary vibrational dental device, loose teeth of the patient for less than about 20 minutes, for example for about 5 minutes, daily at a frequency between about 20 Hz and about 250 Hz, such as at a frequency higher than about 80 Hz over a treatment period. The method may further include mechanically stimulating cells in the PDL surrounding the loose teeth. The cells may include at least one of human osteoblasts and fibroblasts. The treatment period may extend for about a couple of days, about a up to a number of months, at the end of which, the number of the cells increases. In some embodiments, at the end of the treatment period, the alveolar bone, cementum, and/or PDL fiber attachments surrounding the loose teeth are regenerated, causing remodeling of alveolar bone and cementum and tightening up of the loose teeth.

According to another aspect of the present disclosure, a method for treating reducing loose dentition by accelerating aligner treatment is described. The method includes treating the teeth of a patient that are treated with orthodontic aligners in a pre-determined sequence for a treatment period. The method includes providing the mouthpiece of the vibrational dental device between the occlusal surfaces of the patient's teeth to be clamped by the patient's teeth. The method further includes mechanically stimulating, using the vibrational dental device, the teeth of the patient, for less than about 20 minutes, for example for about 5 minutes, at a frequency between about 20 Hz and about 250 Hz, such as at a frequency higher than 80 Hz daily over a treatment period, such as about fewer than 14 days. In some embodiments, the method includes increasing vascularity and circulation in the PDL surrounding the treated teeth at the end of the treatment period. In some embodiments, the method further includes reducing root resorption of the treated teeth at the end of the treatment period.

In some embodiments, the method further includes applying an axial vibratory force on the occlusal surfaces by the vibrational dental device. In some embodiments, the vibrational frequency and/or the acceleration magnitude generated by the vibrational dental device may be adjusted. Such adjustment may depend on one or more factors, such as the speed of tooth movement, the patient's reported comfort level, the extent of root resorption, the degree of loose dentition, and/or the patient's compliance level.

Reference will now be made in detail to embodiments and aspects of the present disclosure, examples of which are illustrated in the accompanying drawings. Where possible, the same reference numbers will be used throughout the drawings to refer to the same or like parts.

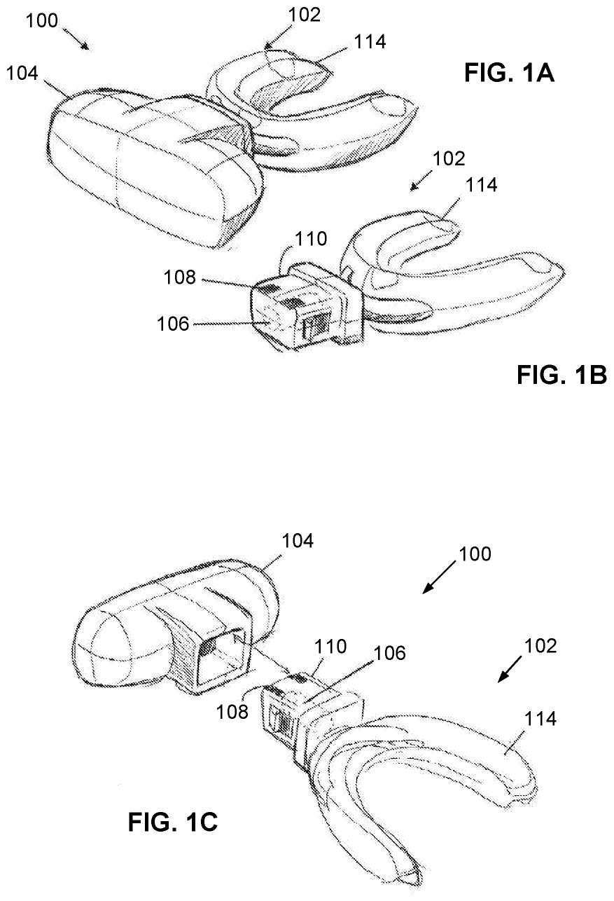

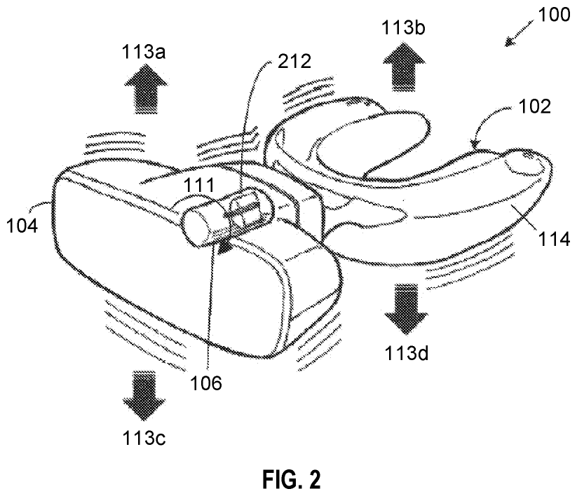

FIG. 1A is a perspective view of an exemplary vibrational dental device 100. FIG. 1B is a partial perspective view of vibrational dental device 100. FIG. 1C is a component view of vibrational dental device 100. As shown in FIGS. 1A-1C, vibrational dental device 100 includes a mouthpiece 102, a base 104, and a motor 106. Mouthpiece 102 is removably attached to base 104. Mouthpiece 102 includes a biteplate 114 and a mouthpiece extension 110 configured to connect with base 104. In some embodiments, mouthpiece 102 and/or biteplate 114 can be configured to engage some or all of a user's teeth. For example, in the exemplary embodiments shown in FIGS. 1A-2, mouthpiece 102 and/or biteplate 114 are shaped to engage some or all of a user's teeth. As described herein, the shape of mouthpiece 102 and/or biteplate 114 shown in FIGS. 1A-2 is only exemplary. Mouthpiece 102 and/or biteplate 114 may have a U-shape or a C-shape as depicted, or a customized shape suitable for safe application of vibrational treatment to all or some of a user's teeth, or even a single tooth, and/or sitting against an orthodontic aligner on the user's teeth. In some embodiments, mouthpiece 102 and/or biteplate 114 may have any suitable shape to sit against the occlusal surface, the labial surface, or the lingual surface of the orthodontic aligner over the user's teeth. In some embodiments, biteplate 114 may have surface textural and topographical variations, such as ridges, corresponding to surface variations of the occlusal surface of the orthodontic aligner over the user's teeth. As a non-limiting example, mouthpiece 102 and/or biteplate 114 can have any suitable shape or surface texture to contact all or selected occlusal surfaces of the orthodontic aligner. The mouthpiece can be made to apply vibration directly to a user's teeth, or to aligners or other orthodontic appliances, such as braces, applied to the teeth. Extension 110 may further include contacts 108 that electrically connect base 104 with motor 106.

As shown in FIGS. 1B and 1C, motor 106 is installed in extension 110 of mouthpiece 102. When mouthpiece 102 is attached to base 104, motor 106 resides in base 104. Base 104 further includes electronic circuitries (not shown), including a control circuitry and a power circuitry, for operating motor 106. Motor 106 may be any type of motor that can cause mouthpiece 102 or biteplate 114 to vibrate. For example, motor 106 could be a vibration motor, piezoelectric motor, a linear motor, or an electromagnetic motor. The frequency and/or strength of vibration caused by motor 106 can be adjusted by changing the voltage or current supplied to motor 106 by the electronic circuitries in base 104. For example, the voltage used for operating motor 106 may range from about 0.5 volt to about 4 volts. The current supplied to an exemplary motor 106 may range from about 65 mA to about 100 mA.

Motor 106 may have any suitable mechanical configurations to cause mouthpiece 102 or biteplate 114 to vibrate axially. FIG. 2 illustrates an exemplary operation of vibrational dental device 100. As shown in FIG. 2, in one embodiment, motor 106 is a counter-weighted motor with a longitudinal axis parallel to the longitudinal axis of extension 110. Motor 106 may include a counterweight 212 that is off-axis from the longitudinal axis of motor 106. In an exemplary embodiment, when the motor 106 rotates, as shown by the arrow 111 in FIG. 2, counterweight 212 moves up and down, causing the mouthpiece 102 to vibrate up and down, as shown by the arrows 113a-113d in FIG. 2. The vibrator can be arranged to create vibration in two or three axes. Accordingly, when the exemplary mouthpiece 102 is placed between a user's teeth, and when exemplary vibrational dental device 100 is turned on, the vibration of mouthpiece 102 will apply a vibratory force on the occlusal surfaces of the teeth. For example, biteplate 114 of mouthpiece 102 in an exemplary embodiment may cyclically move axially between the occlusal surfaces of the teeth. In other embodiments, the biteplate 114 of mouthpiece 102 may cyclically move in one or more of the three spatial axes.

In some embodiments, vibrational dental device 100 may further include one or more sensors (not shown), such as piezoelectric sensors, configured to detect the acceleration magnitude and/or frequency of the vibration of mouthpiece 102. For example, sensors may be placed on the outside or the inside edge of biteplate 114, proximate to the occlusal surfaces of the teeth when mouthpiece 102 is clamped between the occlusal surfaces. The sensors can be electrically connected to the electronic circuitries in base 104. Measurements of the sensors can be fed back to the control circuitry of motor 106 to adjust the acceleration magnitude and/or frequency of motor 106. For example, the detected acceleration magnitude and/or frequency may be compared to a desired acceleration magnitude and/or frequency, and the voltage and/or current supplied to motor 106 can be adjusted based on the comparison.

In some embodiments, motor 106 is configured to vibrate mouthpiece 102 at a frequency between about 20 Hz and about 250 Hz, such as at a frequency higher than 80 Hz, between about 120 Hz to about 130 Hz, between about 110 Hz to about 120 Hz, between about 100 Hz to about 110 Hz, between about 90 Hz to about 100 Hz, between about 80 Hz to about 90 Hz, between about 80 Hz to about 100 Hz, between about 90 Hz to about 110 Hz, between about 100 Hz to about 120 Hz, between about 110 Hz to about 130 Hz, between about 120 Hz to about 140 Hz, between about 100 Hz to about 140 Hz, between about 120 Hz to about 160 Hz, between about 140 Hz to about 180 Hz, between about 160 Hz to about 200 Hz, between about 180 Hz to about 120 Hz, or between about 200 Hz to about 250 Hz, and more specifically at a frequency at or about 100 Hz or 120 Hz. Motor 106 may be further configured to vibrate mouthpiece 102 at an acceleration magnitude ranging between about 0.01 G and about 1 G, such as between about 0.03 G and about 0.2 G. As described herein, the vibrational frequency of mouthpiece 120 may vary from the rated “free-air” vibrational frequency of motor 106 due to the amount of biting force or load applied to mouthpiece 102, such as the force used to clamp vibrational dental device 100 in place. For example, when motor 106 is configured to vibrate at a frequency of or about 120 Hz, adding biting force or load to mouthpiece 102 may result in a lower vibrational frequency of mouthpiece 102 ranging from about 100 Hz to about 120 Hz.

In some embodiments, vibrational dental device 100 can be used for applying vibrational treatment to all or some of a patient's teeth for a daily treatment period. The daily treatment period can be, for example, less than about 20 minutes, 15 minutes, 10 minutes, 6 minutes, 5 minutes, 4 minutes, or less. It is contemplated that in other embodiments the treatment period could be any value within the range of about 1 minute and 19 minutes daily, and that the daily total treatment period could be formed of a plurality of treatment sessions contributing to the daily total treatment period. In some embodiments, vibrational treatment of a patient's teeth may be applied over an orthodontic treatment period, such as an aligner treatment period over about 5 to about 7 days, about 7 days to about 14 days, about 14 days to about 30 days, or about 1 month to a few months, or about any number of days fewer than 14 days.

Examples 1-3 described below illustrate the use of vibrational dental device 100 operating under these variables and its clinically relevant effects.

### Example 1

An exemplary embodiment of vibrational dental device 100 is used to mechanically stimulate periodontal cells surrounding loose teeth of a patient for a treatment period. The periodontal cells include human osteoblasts in alveolar bone and periodontal ligament fibroblasts. The periodontal cells are treated for less than about 20 minutes, for example for about 5 minutes, at a frequency from about 20 Hz to about 250 Hz, for example from about 100 Hz to about 120 Hz, daily over a period of time, which lasts for about a couple of days to a couple of weeks, such as about 7 days. At the end of the treatment period, the number of periodontal cells, including osteoblasts in alveolar bone and periodontal ligament fibroblasts, is increased. The alveolar bone and PDL fiber attachments surrounding the loose teeth are regenerated, causing regeneration and remodeling of alveolar bone and PDL surrounding the loose teeth and tightening up of the loose teeth.

### Example 2

An exemplary embodiment of vibrational dental device 100 is used to mechanically stimulate loose teeth of a patient for a treatment period. The loose teeth are treated for less than about 20 minutes, for example for about 5 minutes, at a frequency from about 20 Hz to about 250 Hz, for example from about 100 Hz to about 120 Hz, daily over a period of time, which lasts for about a couple of days to a couple of weeks, such as about 7 days. At the end of the treatment period, vascularity and circulation in the PDL surrounding the treated loose teeth is increased and the loose teeth are tightened.

### Example 3

An exemplary embodiment of vibrational dental device 100 is used to treat a patient experiencing loose dentition in aligner treatment for a treatment period. Loose teeth of the patient are treated for less than about 20 minutes, for example for about 5 minutes, at a frequency from about 20 Hz to about 250 Hz, for example from about 100 Hz to about 120 Hz, daily over a period of time, which lasts for about a couple of days to a couple of weeks, such as about 7 days. At the end of the treatment period, cementum of the root of the loose teeth are regenerated, root resorption of the loose teeth is reduced, and the loose teeth are tightened.

While the description herein is directed to orthodontic aligners, the instant disclosure is applicable to other orthodontic modalities where a static force is applied to one or more teeth over a period of time, for example bracket-and-wire braces or orthodontic appliances.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for treating a patient experiencing loose dentition in aligner treatment, the method comprising:
providing a vibrational dental device configured to vibrate at a frequency higher than about 80 Hz; and
providing instructions for treating teeth of a patient with orthodontic aligners, the aligners configured to be worn in the mouth of the patient in a pre-determined sequence to move the patient's teeth substantially into a desired alignment, wherein the instructions for treating include
instructions for mechanically stimulating, using the vibrational dental device, loose teeth of the patient for about five minutes daily while the patient is wearing the aligners,
wherein the treatment tightens the loose teeth in their sockets during aligner treatment.

2. The method of claim 1, wherein the treatment reduces root resorption of the loose teeth.

3. The method of claim 2, wherein the treatment reduces root resorption of the loose teeth by between about 10% and about 75%.

4. The method of claim 1, wherein the treatment stimulates the growth of periodontal cells, including at least one of human osteoblasts and fibroblasts, around the loose teeth.

5. The method of claim 1, wherein the device is configured to vibrate at an acceleration magnitude ranging between about 0.01 G and about 1 G.

6. The method of claim 1, further comprising mechanically stimulating the teeth at a frequency between about 80 Hz and about 250 Hz.

7. The method of claim 1, further comprising mechanically stimulating the teeth at a g-force between about 0.01 G and about 1 G.

8. The method of claim 1, further comprising treating the teeth with each aligner in the pre-determined sequence until the teeth are substantially in the desired alignment.

9. The method of claim 1, wherein the device comprises a mouthpiece and a motor connected to and configured to vibrate the mouthpiece.

10. The method of claim 7, further comprising providing the mouthpiece between occlusal surfaces of the teeth to be clamped by the teeth.

11. The method of claim 7, further comprising detecting vibration characteristics of the mouthpiece.

12. The method of claim 1, further comprising adjusting the frequency and/or g-force of the vibration of the device.

13. The method of claim 1, wherein the mechanical stimulation accelerates movement of the teeth substantially into the desired alignment.

14. The method of claim 1, wherein the teeth are treated with each aligner for a treatment period of less than 14 days.

15. The method of claim 1, wherein the mechanical stimulation of the teeth with the device reduces a treatment time of the aligner treatment by at least about 50%.

16. A method for reducing loose dentition by accelerating aligner treatment, the method comprising:
providing instructions for treating teeth of a patient that are treated with orthodontic aligners in a pre-determined sequence for a treatment period;
wherein for at least one aligner, the instructions for treating the teeth of the patient include instructions for accelerating teeth movement by mechanically stimulating, using a vibrational dental device, the teeth at a frequency higher than about 80 Hz for about five minutes daily while the patient is wearing the at least one aligner, the treatment period for the at least one aligner being about 14 days or fewer; and
wherein the acceleration of teeth movement due to the mechanical stimulation reduces loosening of the patient's teeth.

17. The method of claim 1, wherein the acceleration of teeth movement reduces root resorption of the patient's teeth.

18. The method of claim 17, wherein the acceleration reduces root resorption of the patient's teeth by between about 10% and about 75%.

19. The method of claim 16, wherein the treatment stimulates the growth of periodontal cells, including at least one of human osteoblasts and fibroblasts, around the patient's teeth.

20. The method of claim 16, wherein the device is configured to vibrate at an acceleration magnitude ranging between about 0.01 G and about 1 G.

21. The method of claim 16, further comprising mechanically stimulating the teeth at a frequency between about 80 Hz and about 250 Hz.

22. The method of claim 16, further comprising mechanically stimulating the teeth at a g-force between about 0.01 G and about 1 G.

23. The method of claim 16, wherein the mechanical stimulation of the teeth with the device reduces a treatment time of the aligner treatment by at least about 50%.

24. A dental device for reducing loose dentition in aligner treatment, the dental device comprising means for
mechanically stimulating teeth of a patient at a frequency higher than about 80 Hz for about 5 minutes daily while the patient is wearing an aligner; and
reducing loosening of the patient's teeth.

25. A method for treating a patient experiencing loose dentition in aligner treatment, the method comprising:
obtaining orthodontic aligners, the orthodontic aligners configured to be worn in the mouth of a patient in a pre-determined sequence to move the patient's teeth substantially into a desired alignment;
obtaining a vibrational dental device configured to vibrate at a frequency higher than about 80 Hz;
treating the teeth of a patient with the orthodontic aligners in the pre-determined sequence; and
mechanically stimulating, using the vibrational dental device, loose teeth of the patient for about five minutes daily while the patient is wearing each orthodontic aligner,
wherein the treatment tightens the loose teeth in their sockets during aligner treatment.
